(19) United States
(12) Patent Application Publication
(10) Pub. No.: US 2025/0015881 A1
(43) Pub. Date: Jan. 9, 2025

(54) PORTABLE COMMUNICATION APPRARATUS

(71) Applicant: Geoffrey Michael Larkin Adrian, Camano Island, WA (US)

(72) Inventor: Geoffrey Michael Larkin Adrian, Camano Island, WA (US)

(21) Appl. No.: 18/218,687

(22) Filed: Jul. 6, 2023

(51) Int. Cl. H04B 7/185

(52) U.S. Cl. CPC H04B 7/18517

(57) ABSTRACT

A portable communication apparatus is disclosed, including a satellite communication unit in communication with one or more satellites. A power storage device supplies power to the satellite communication unit and a main unit is in operable communication with the satellite communication unit. At least one adapter is in electrical communication with at least one I/O device. A portable protective case houses the satellite communication unit, the main unit, the power storage device, and the at least one adapter and is capable of being selectively mounted to a vehicle, object, or structure.

### TECHNICAL FIELD

The embodiments disclosed herein generally relate to a portable communication apparatus.

### BACKGROUND

With advances in technology, satellite communication devices have become increasingly popular. Satellites are now used in telephony, television, radio broadcasting, Internet, military, and data collection for both the civilian and military populations. Communications satellites relay and amplify telecommunication signals via a transponder and create a communication channel between the source transmitter and receiver at various locations around earth.

In particular, Starlink has provided a means for global Internet access. A user terminal (e.g., an antenna dish) allows access to the Starlink satellite network. While effective, these user terminals are stationary. 12-volt adaptations to the user terminals are available but do not provide a completely portable kit which may be used in non-permissive environments.

### SUMMARY OF THE INVENTION

This summary is provided to introduce a variety of concepts in a simplified form that is further disclosed in the detailed description of the embodiments. This summary is not intended for determining the scope of the claimed subject matter.

In general, the embodiments provided herein relate to a portable communication apparatus, including a satellite communication unit in communication with one or more satellites. A power storage device supplies power to the satellite communication unit and a main unit is in operable communication with the satellite communication unit. At least one adapter is in electrical communication with at least one I/O device. A portable protective case may optionally house the satellite communication unit, the main unit, the power storage device (fuse block), and the at least one adapter and is capable of being selectively mounted to a vehicle, object, or structure.

The apparatus provides a portable means of carrying a self-contained satellite communication system which may be used in non-permissive environments. Power for the communication device can come from any 12-volt powered source, such as a car, solar generator, battery, or battery pack. The embodiments provide for a portable and functional communication system which may be powered by various power sources depending on the user's environment.

In one aspect, the at least one adapter permits electrical communication with an external power source such as a vehicle battery, solar cell, or external battery.

In one aspect, the main unit may further comprised of a modem/router to provide communication means to the satellite.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a schematic of the portable satellite communication apparatus, according to some embodiments; and

FIG. 2 illustrates a block diagram of the main unit of the portable satellite communication apparatus, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relates to an apparatus comprised of portable communication device that can function on various power sources. The communication device is enclosed inside a convenient carrying case that includes a 12 volt to 48/56-volt battery transistor and a printed circuit board (PCB). The PCB has an attachment allows for a connection to various power sources. Using the transistor, the power for the communication device can come from any 12-volt powered source, such as a car, solar generator, battery, or battery pack. The embodiments provide for a portable and functional communication system which may be powered by various power sources depending on the user's environment.

In some embodiments, the apparatus allows for the use of a Starlink or satellite communication device (collectively referred to as the satellite communication device) which may be contained within the protective case. A 12-volt power source may be in electrical communication with the satellite communication device to provide power thereto. In such, the apparatus may be wired to and powered by a vehicle, a solar cell, a battery, or other power source.

In some embodiments, the apparatus includes an adapter which operates utilizing about 12-volts. One skilled in the arts will readily understand that the apparatus may be utilize using between 11-72 volts, or a similar voltage known in the arts as useful in like systems.

In some embodiments, the apparatus includes a protective case which allows for efficient transportation of the portable satellite communication system.

In some embodiments, the apparatus is configured to be powered by a vehicle battery and/or by a solar cell and/or solar generator. The portable communication apparatus may include various adapter cables to permit the adaptation to various power supplies (e.g., a vehicle battery, solar cell, solar generator, battery, or other about 12-volt power source).

In some embodiments, the portable communication apparatus may be mounted to a vehicle, or stationary object or structure. In such, the protective case may include a mount to permit the stable mounting of the apparatus to the vehicle, object, or structure.

In some embodiments, 12-volt power (or about 12-volt power commonly utilized in a vehicle, structure, object, etc.) is supplied to a voltage converter to increase the voltage to the required voltage for the satellite unit. Power from the voltage converter is supplied to the adaptor that powers the satellite unit and provides data from the satellite unit to a modem and or router. The modular unit can be use by itself hard wired to a vehicle. The modular unit can be used in a protective case in a portable fashion powered externally. In such, the apparatus can be used as part of a complete self-sustaining unit with attached battery pack when attached to a solar panel.

In some embodiments, the main unit may be selectively removed and engaged with the portable protective case. In such, the main unit is fully capable of performing the various functionalities described herein, with or without the use of the protective case.

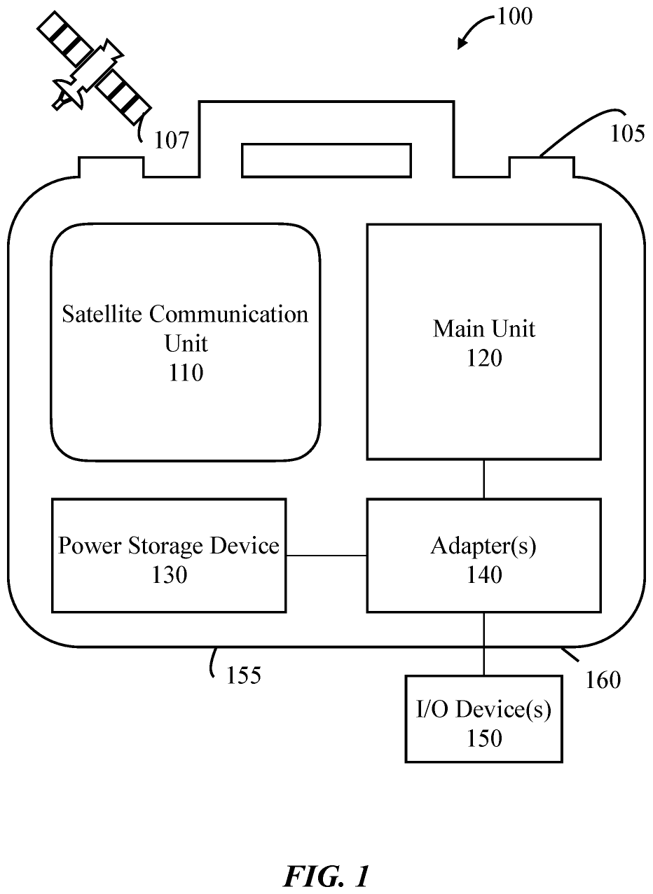

FIG. 1 illustrate a schematic of the apparatus 100 which enables portable satellite communications. The apparatus 100 includes a protective case 105 which houses a satellite communicate unit 110 (i.e., satellite unit storage) to communicate with a satellite 107, a main unit 120, a power storage device 130, and adapter(s) 140. The adapter 140 is used to connect to various I/O devices 150. The protective case 105 is operable to house the various components of the apparatus 100 within its interior to provide protection from the elements, resistance to shock, contaminants (e.g., moisture, dust, etc.), and otherwise protect the apparatus 100.

In some embodiments, the protective case 105 includes mounting components 155 which provide a means for mounting the protective case 105 to a vehicle, structure, or other object. The mounting components 155 may be one or more brackets, hook-and-loop systems, bolts, or other fasteners which secure the protective case 105 to mounting surface.

In some embodiments, the apparatus 100 is portable such that it may be easily carried and transported by the user. The apparatus 100 is configured as a self-sufficient unit and is self-powered via the power storage device 130 or other power source such as a vehicle battery, solar cell, etc. The power storage device 130 may be removeable and changeable to allow for efficient restoration of a power supply to the apparatus 100.

In some embodiments, the power storage device 130 is an optional component within the main unit which may be used if external power is not feasible or not available.

In some embodiments, the I/O device(s) 150 include various devices which may be in electrical communication with the apparatus 100 via I/O ports 160. The I/O devices 150 may include as video device(s) (e.g., a camera), audio device(s), and display(s) are in operable communication with the apparatus. In some embodiments, similar I/O devices 150 may be separate from the apparatus and may interact with one or more nodes of a network through a wired or wireless connection, such as over the communication interface.

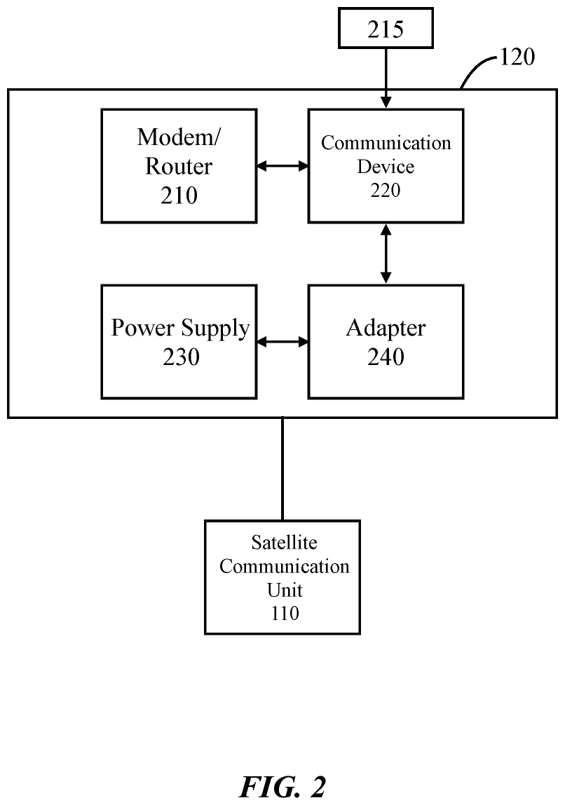

FIG. 2 illustrates a block diagram of the main unit 120 and its components which include a modem/router 210, communication device 220, power supply 230, and adapter 240. The modem/router 210 provides means of communicating with the satellite and may accomplish this using various means known in the arts. Power supply 230 may include a vehicle battery, battery pack, portable power adapter, solar cell, or other means of receiving power. The adapter 240 may include a 11 volt to 72-volt battery transistor (or similar adapter known in the arts). An ethernet cable 215 or other communication input may be provided and selectively used. Satellite communication unit 110 may include various means for communicating with the satellite communication system.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A portable communication apparatus, comprising:
a satellite communication unit in communication with one or more satellites;
a power storage device to supply power to the satellite communication unit;
a main unit in operable communication with the satellite communication unit, the main unit including a PCB;
at least one power source in electrical communication with at least one I/O device,
wherein the main unit includes the satellite communication unit, the main unit, the power storage device.

2. The portable communication apparatus of claim 1, wherein a portable protective case includes at least one mounting component to permit the selective mounting to a vehicle.

3. The portable communication apparatus of claim 2, wherein the at least one mounting component allows for mounting to an object.

4. The portable communication apparatus of claim 2, wherein the at least one mounting component allows for mounting to a structure.

5. The portable communication apparatus of claim 1, wherein the at least one adapter permits electrical communication with an external power source.

6. The portable communication apparatus of claim 5, wherein the external power source is a vehicle battery.

7. The portable communication apparatus of claim 5, wherein the external power source is a solar cell.

8. The portable communication apparatus of claim 1, further comprising a 11 volt to 72-volt battery transistor.

9. The portable communication apparatus of claim 1, wherein the main unit is further comprised of a modem/router to provide communication means to the satellite.

10. The portable communication apparatus of claim 1, wherein the main unit is housed within a portable protective case.

11. A portable communication apparatus, comprising:
a portable protective case to house a satellite communication unit in communication with one or more satellites and a power storage device to supply power to the satellite communication unit;
a main unit in operable communication with the satellite communication unit, the main unit including a PCB, wherein the main unit is housed within a portable protective case;
at least one adapter housed within the portable protective case, the at least one adapter in electrical communication with at least one I/O device to transmit input from the I/O device to the main unit; and
at least one mounting component to permit selective mounting of the portable protective case.

12. The portable communication apparatus of claim 11, wherein the at least one mounting component allows for mounting to an object.

13. The portable communication apparatus of claim 11, wherein the at least one mounting component allows for mounting to a structure.

14. The portable communication apparatus of claim 11, wherein the at least one adapter permits electrical communication with an external power source.

15. The portable communication apparatus of claim 14, wherein the external power source is a vehicle battery.

16. The portable communication apparatus of claim 15, wherein the external power source is a solar cell.

17. The portable communication apparatus of claim 11, further comprising a 11 volt to 72-volt battery transistor.

18. The portable communication apparatus of claim 11, wherein the main unit is further comprised of a modem/router to provide communication means to the satellite.
